(19) United States
(12) Patent Application Publication
(10) Pub. No.: US 2013/0271568 A1
(43) Pub. Date: Oct. 17, 2013

(54) TRANSMITTING SYSTEM AND RECEIVING APPARATUS FOR PROVIDING HYBRID SERVICE, AND SERVICE PROVIDING METHOD THEREOF

(71) Applicants: SAMSUNG ELECTRONICS CO., LTD., Suwon-si (KR); ELECTRONICS AND TELECOMMUNICATIONS RESEARCH INSTITUTE, Daejeon (KR)

(72) Inventors: Hong-seok PARK, Ansan-si (KR); Hyun-jeong YIM, Seoul (KR); Hyoung-jin KWON, Cheongju-si (KR); Hee-jean KIM, Yongin-si (KR); Kug-jin YUN, Daejeon (KR); Gwang-soon LEE, Daejeon (KR); Jae-jun LEE, Suwon-si (KR); Jin-young LEE, Daejeon (KR); Yong-seok JANG, Hwaseong-si (KR); Won-sik CHEONG, Daejeon (KR); Seong-sin JOO, Suwon-si (KR); Yu-sung JOO, Yongin-si (KR); Nam-ho HUR, Daejeon (KR); Sung-oh HWANG, Yongin-si (KR)

(73) Assignees: Electronics and Telecommunications Research Institute, Daejeon (KR); Samsung Electronics Co., Ltd., Suwon-si (KR)

(21) Appl. No.: 13/861,848

(22) Filed: Apr. 12, 2013

Related U.S. Application Data
(60) Provisional application No. 61/623,789, filed on Apr. 13, 2012.

(30) Foreign Application Priority Data
Oct. 15, 2012 (KR) 10-2012-0114461

(51) Int. Cl. H04N 13/00

(52) U.S. Cl. CPC H04N 13/0051
USPC 348/43; 348/473

(57) ABSTRACT

A receiving apparatus includes a first receiving unit that receives a first signal comprising an information descriptor to describe service characteristics, reference data, and additional data reference information through a RF communication network; a second receiving unit that can be connected to an IP network; a demux unit that detects the information descriptor from the first signal; a first signal processing unit that processes the reference data; a control unit that, if it is determined as a hybrid service depending on the information descriptor, controls the second receiving unit to access a source apparatus corresponding to the additional data reference information; a second signal process unit that, if a second signal comprising additional data is received through the IP communication network, processes the additional data; and an output unit that synchronizes and outputs the reference data and the additional data.

### CROSS-REFERENCE TO RELATED APPLICATIONS

This application claims priority from U.S. Provisional Application No. 61/623,789, filed Apr. 13, 2012, in the United States Patent & Trademark Office, and Korean Patent Application No. 10-2012-0114461, filed Oct. 15, 2012, in the Korean Intellectual Property Office, the disclosures of which are incorporated herein by reference in their entirety.

### BACKGROUND

1. Field

Systems, apparatuses, and methods consistent with exemplary embodiments relate to a transmitting system, a receiving apparatus, and service providing methods thereof More particularly, the present disclosure relates to a transmitting system and a receiving apparatus for providing a hybrid service by using an information descriptor, and service providing methods thereof.

2. Description of the Related Art

Thanks to the development of electronic technology, various types of electronic apparatuses have been developed and have spread. Receiving apparatuses such as a TV may be cited as one example of these electronic apparatuses.

Recently, because of the improvements in TV performance, multimedia content such as 3D content or full HD content is being supported. These types of content have data sizes greater than the existing content.

However, a transmission bandwidth that is used in the broadcasting network is limited. Accordingly, there is a limitation on the size of the content that can be transmitted in the current broadcasting network. In order to meet this limitation, the resolution of the content inevitably needs to be reduced, and, as a consequence, there is a problem that the image quality thereof is degraded.

Attempts to provide various kinds of media data through various transmission environments have been made in order to solve these problems. However, since mechanisms to provide these services are different from the existing broadcasting service mechanism, it is difficult to have compatibility with the existing broadcast receiving apparatuses. Also, there is a problem that data that are transmitted through different paths cannot be synchronized appropriately by the receiving apparatus.

### SUMMARY

The present disclosure has been developed in order to overcome the above drawbacks and other problems associated with the conventional arrangement. An aspect of the present disclosure is to provide a transmitting system and a receiving apparatus that can selectively provide a hybrid service by using an information descriptor, and a service providing method thereof.

The above aspect and/or other feature of the present disclosure can substantially be achieved by providing a receiving apparatus, which may include a first receiver configured to receive a first signal comprising an descriptor to describe service characteristics, reference data, and additional data reference information through a first network; a second receiver operable to be connected to a second network; a demultiplexer configured to detect the descriptor, the reference data, and the additional data reference information from the first signal; a first signal processor configured to process the reference data detected in the demultiplexer; a controller configured to control the second receiver to access a source apparatus corresponding to the additional data reference information, if a hybrid service is determined based on the descriptor; a second signal processor configured to process the additional data, if a second signal comprising additional data is received from the source apparatus through the second network; and an outputter configured to synchronize and output the reference data processed in the first signal processor and the additional data processed in the second signal processor. The first network may comprise a radio frequency (RF) network and the second network may comprise an internet protocol (IP) network.

The descriptor may include a bit value that specifies a type of service, and the bit value may include at least one from among a first value that indicates a 2D service, a second value that indicates a frame compatible stereoscopic service, a third value that indicates a service compatible stereoscopic service, a fourth value that indicates a hybrid 3DTV streaming service, and a fifth value that indicates a hybrid 3DTV download service.

If the bit value contained in the descriptor is the fourth value, the controller may control the second receiver to access the source apparatus and to perform streaming, and if the bit value contained in the descriptor is the fifth value, the control unit may control the second receiver to access the source apparatus and to perform a download.

The descriptor may be recorded in at least one from among a terrestrial virtual channel table (TVCT), an event information table (EIT), and a program map table (PMT) within the first signal.

The additional data reference information may include at least one from among broadcasting service type information, additional image type information, accessing information related to the addition data, additional image start time information, and synchronizing information.

The additional data reference information may be contained in at least one from among a virtual channel table (VCT), an event information table (EIT) of a program, a system information protocol (PSIP), and one from among a program map table (PMT) and a metadata stream of program specifying information.

According to another aspect of the present disclosure, a service providing method may include receiving a first signal comprising an descriptor to describe service characteristics, reference data, and additional data reference information through a first network; detecting the descriptor from the first signal; accessing, if a hybrid service is determined based on the descriptor, a source apparatus corresponding to the additional data reference information through a second network; receiving a second signal comprising additional data from the source apparatus; processing the reference data contained in the first signal and the additional data contained in the second signal, respectively; and synchronizing and outputting the processed reference data and additional data.

The descriptor may include a bit value that specifies a type of service, and the bit value comprises at least one from among a first value that indicates a 2D service, a second value that indicates a frame compatible stereoscopic service, a third value that indicates a service compatible stereoscopic service, a fourth value that indicates a hybrid 3DTV streaming service, and a fifth value that indicates a hybrid 3DTV download service.

The receiving the second signal may include, if the bit value contained in the descriptor is the fourth value, receiving streaming of the additional data from the source apparatus, and, if the bit value contained in the descriptor is the fifth value, downloading the additional data from the source apparatus.

The descriptor may be recorded in at least one from among a terrestrial virtual channel table (TVCT), an event information table (EIT), and a program map table (PMT) within the first signal.

The additional data reference information may include at least one from among broadcasting service type information, additional image type information, accessing information about the addition data, additional image start time information, and synchronizing information.

The additional data reference information may be contained in at least one from among a virtual channel table (VCT), an event information table (EIT) related to a program, a system information protocol (PSIP), and one from among a program map table (PMT) and a metadata stream of program specifying information.

According to another aspect of the present disclosure, a transmitting system may include a server configured to provide reference data and additional data related to a single content; a first signal processor configured to generate a first signal comprising the reference data, descriptor that describes service characteristics of the content, and additional data reference information; a first transmitter configured to transmit the first signal through a first network; a second signal processor configured to generate a second signal comprising additional data; and a second transmitter configured to transmit the second signal in a form of one of a stream and a file, if a request for the second signal is received from a receiving apparatus.

The descriptor may include a bit value that specifies a type of service, and the bit value comprises at least one from among a first value that indicates a 2D service, a second value that indicates a frame compatible stereoscopic service, a third value that indicates a service compatible stereoscopic service, a fourth value that indicates a hybrid 3DTV streaming service, and a fifth value that indicates a hybrid 3DTV download service.

The descriptor may be recorded in at least one from among a terrestrial virtual channel table (TVCT), an event information table (EIT), and a program map table (PMT) within the first signal.

The additional data reference information may include at least one from among broadcasting service type information, additional image type information, accessing information about the addition data, additional image start time information, and synchronizing information, and the additional data reference information may be contained in at least one from among a virtual channel table (VCT), an event information table (EIT) related to a program, a system information protocol (PRP), and one from among a program map table (PMT) and a metadata stream of program specifying information.

According to another aspect of the present disclosure, a service providing method of a transmitting system may include providing reference data and additional data related to a single content; generating a first signal comprising the reference data, a descriptor that describes service characteristics of the single content, and additional data reference information; transmitting the first signal through a first network; generating a second signal comprising additional data; and transmitting, if a request for the second signal is received from a receiving apparatus, the second signal in a form of one from among a stream and a file.

The descriptor may include a bit value that specifies a type of service, and the bit value comprises at least one from among a first value that indicates a 2D service, a second value that indicates a frame compatible stereoscopic service, a third value that indicates a service compatible stereoscopic service, a fourth value that indicates a hybrid 3DTV streaming service, and a fifth value that indicates a hybrid 3DTV download service.

The descriptor may be recorded in at least one from among a terrestrial virtual channel table (TVCT), an event information table (EIT), and a program map table (PMT) within the first signal.

The additional data reference information may include at least one from among broadcasting service type information, additional image type information, accessing information about the addition data, additional image start time information, and synchronizing information, and the additional data reference information may be contained in at least one from among a virtual channel table (VCT), an event information table (EIT) related to a program, a system information protocol (PSIP), and one from among a program map table (PMT) and a metadata stream of program specifying information.

According to various embodiments as described above, a type of service may be notified to a receiving apparatus by using a descriptor, so a hybrid service can be selectively provided. As a result, without the problem of the lack of resources, the large size of content can be played.

Other objects, advantages and salient features of the present disclosure will become apparent from the following detailed description, which, taken in conjunction with the annexed drawings, discloses preferred embodiments.

### BRIEF DESCRIPTION OF THE DRAWINGS

These and/or other aspects and advantages of the present disclosure will become apparent and more readily appreciated from the following description of the exemplary embodiments, taken in conjunction with the accompanying drawings of which:

FIG. 1 is a view illustrating a configuration of a service providing system according to an exemplary embodiment of the present disclosure;

FIG. 2 is a block diagram illustrating a configuration of a receiving apparatus according to an exemplary embodiment of the present disclosure;

FIG. 3 is an example of syntax of an information descriptor;

FIG. 4 is a table illustrating values that will be included in an information descriptor;

FIG. 5 is an example of syntax of additional data reference information;

FIG. 6 is an example of a structure of a metadata including additional data reference information;

FIG. 7 is an example of a signal structure in which additional data reference information is transmitted in the form of metadata;

FIG. 8 is a flowchart for explaining a service providing method in a receiving apparatus according to an exemplary embodiment of the present disclosure;

FIG. 9 is a block diagram illustrating a configuration of a transmitting system according to an exemplary embodiment of the present disclosure;

FIG. 10 is a block diagram illustrating a detailed configuration of the transmitting system of FIGS. 9; and

FIG. 11 is a flowchart for explaining a service providing method of a transmitting system according to an exemplary embodiment of the present disclosure.

Throughout the drawings, like reference numerals will be understood to refer to like parts, components and structures.

### DETAILED DESCRIPTION OF THE EXEMPLARY EMBODIMENTS

Hereinafter, certain exemplary embodiments of the present disclosure will be described in detail with reference to the accompanying drawings.

The matters defined herein, such as a detailed construction and elements thereof, are provided to assist in a comprehensive understanding of this description. Thus, it is apparent that exemplary embodiments may be carried out without those defined matters. Also, well-known functions or constructions are omitted to provide a clear and concise description of exemplary embodiments. Further, dimensions of various elements in the accompanying drawings may be arbitrarily increased or decreased for assisting in a comprehensive understanding.

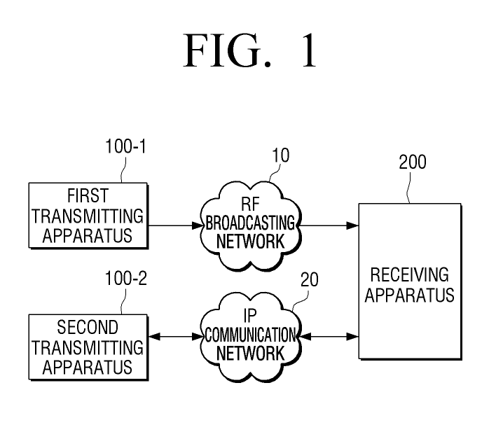

FIG. 1 is a view illustrating a configuration of a service providing system according to an exemplary embodiment of the present disclosure. Referring to FIG. 1, a service providing system includes a plurality of transmitting apparatuses 100-1 and 100-2, and a receiving apparatus 200. FIG. 1 illustrates only one receiving apparatus 200; however, a plurality of receiving apparatus 200 may be provided.

The plurality of transmitting apparatuses 100-1 and 100-2 transmits signals through different communication networks. FIG. 1 is illustrated so that a first transmitting apparatus 100-1 transmits signals through a radio frequency (RF) communication network 10 and a second transmitting apparatus 100-2 transmits signals through an internet protocol (IP) communication network 20; however, those do not limit the kind of the communication network. For convenience of explanation, in the below description, a signal that the first transmitting apparatus 100-1 transmits is referred to as a first signal, and a signal that the second transmitting apparatus 100-2 transmits is referred to as a second signal.

Each of the first and second signals may include data divided in order to configure content. For example, video data of 3D content may be divided into left eye image data and right eye image data. In this case, one of the left eye and right eye image data may be included in the first signal, and thus, may be transmitted through the RF communication network. The other one thereof may be included in the second signal, and thus, may be transmitted through the IP communication network. In addition, the content may be divided into by a variety of criteria such as video data and audio data, moving image data and subtitles data, etc., and then, may be transmitted by each of the first and second signals. For convenience of explanation, in this description, data contained in the first signal is defined as reference data, and data contained in the second signal is defined as additional data.

A way and a configuration for transmitting signals through the RF communication network 10 may be implemented differently according to broadcasting standards. In other words, digital broadcasting standards may include advanced television system committee (ATSC), digital video broadcasting (DVB), integrated services digital broadcasting-terrestrial (ISDB-T), etc.

The detailed configuration and operations of the first transmitting apparatus 100-1 that transmits the first signal through the RF communication network 10 may vary depending on which one of the above-described broadcasting standards is applied. The configuration and operations of the receiving apparatus 200 are also the same.

For example, if the ATSC standard is applied, the first transmitting apparatus 100-1 may include a randomizing unit, a reed-Solomon (RS) encoder, a data interleaver, a trellis encoder, a sink and pilot insertion unit, an 8-vestigial side band (VSB) modulation unit, a radio frequency (RF) up converter, an antenna, etc. On the other hand, the receiving apparatus 200 may include an antenna, a radio frequency (RF) down converter, a demodulator, an equalizer unit, a demultiplexer, a reed-Solomon (RS) decoder, a deinterleaver, etc. Since the detailed configuration for signal transmission and reception of each broadcasting standards is specifically disclosed in the standard document of each broadcasting standards, detailed illustration and description thereof will be omitted.

The first signal transmitted from the first transmitting apparatus 100-1 may include the reference data among several data that were divided from a single content as described above.

The first signal may further include an information descriptor and additional data reference information in addition to the reference data. The information descriptor means information that describes the characteristics of service provided by the first transmitting apparatus 100-1. In detail, the first transmitting apparatus 100-1 may provide a general service to singly transmit 2D content or 3D content to the receiving apparatus 200, and also may provide a hybrid service to share and transmit a single content with the second transmitting apparatus 100-2 so that the receiving apparatus 200 combines and plays it. The first transmitting apparatus 100-1 may transmit the information descriptor a value of which is differently set depending on the type of service provided. The information descriptor may be recorded and provided in a variety of areas such as a terrestrial virtual channel table (TVCT), an event information table (EIT), a program map table (PMT), etc. within the first signal. A transmitting way and configuration of the information descriptor will be described in detail later.

The additional data reference information means information that is referred to receive a second signal separately from the first signal and to process the second signal with the first signal. The additional data reference information may be included in the first signal only when the information descriptor specifies the hybrid service; however, it is not limited thereto. In other word, according to another exemplary embodiment of the present disclosure, it may be implemented so that the additional data reference information is basically included in the first signal, and thus, only when the information descriptor specifies the hybrid service, the receiving apparatus 200 refers the additional data reference information. The additional data reference information may be provided to the receiving apparatus 200 in a variety of methods. In detail, the additional data reference information may be provided to through a virtual channel table (VCT), or an event information table (EIT) of a program and system information protocol (PSIP), a program map table (PMT) or a metadata stream of program specifying information, etc. of the first signal.

The second transmitting apparatus 100-2 transmits the second signal including the additional data to the receiving apparatus 200 through the IP communication network 20. The IP communication network 20 may be implemented as various types of networks such as webs, cloud networks, local networks, etc. The second transmitting apparatus 100-2 may transmit the second signal in a streaming way. In detail, a variety of streaming ways such as a real time protocol (RTP), a hypertext transfer protocol (HTTP), etc. may be used. According to another exemplary embodiment of the present disclosure, the second transmitting apparatus 100-2 may provide the additional data in a download manner. In the case of the download manner, the file format thereof may be various foil is such as avi, mp4, mpg, mov, wmv, etc.

The receiving apparatus 200 may be implemented as various types of apparatuses, such as a broadcast receiving apparatus such as a set top box, a television, a cell phone, a personal digital assistant (PDA), a set top personal computer (PC), a personal computer, a notebook computer, a kiosk, etc. If the first signal is received from the first transmitting apparatus 100-1, the receiving apparatus 200 detects and checks the information descriptor from the first signal. If the general service is determined from the check result, the receiving apparatus 200 decodes video data, audio data, and other data contained in the first signal, and thus, outputs them through a screen and a speaker.

On the other hand, if the service is determined to be the hybrid service, the receiving apparatus 200 detects the additional data reference information from the first signal. The additional data reference information may include at least one of a variety of information such as broadcast service type information, additional image type information, accessing information about addition data, additional image start time information, synchronizing information, etc. The receiving apparatus 200 may access the second transmitting apparatus 100-2 by using the accessing information. The receiving apparatus 200 may request the second transmitting apparatus 100-2 to transmit the additional data. In response to the transmitting request of the additional data, the second transmitting apparatus 100-2 transmits the second signal including the additional data as described above.

The receiving apparatus 200 synchronizes the reference data within the first signal and the additional data within the second signal by using the synchronizing information within the additional data reference information, and thus, outputs them. A variety of information may be used as the synchronizing information. In detail, a variety of information, such as a time code, a frame index, content start information, difference between values of timestamps, UTC information, frame count information, etc., may be used as the synchronizing information. A synchronizing method using the synchronizing information will be described in more detail later.

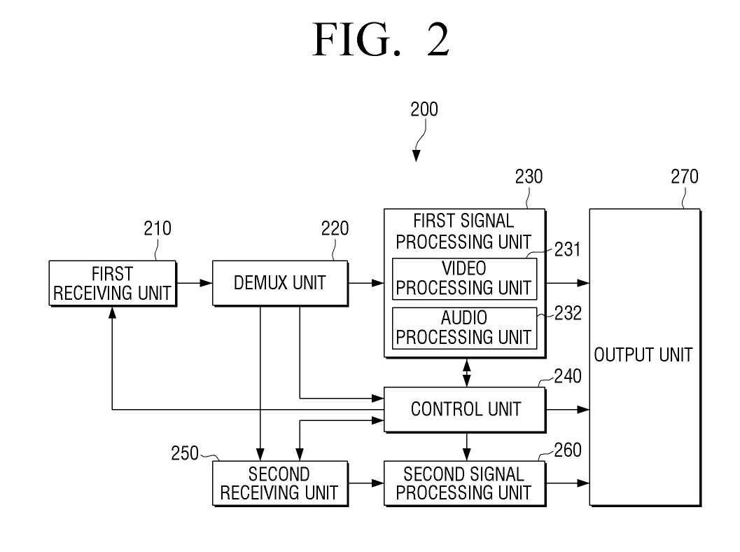

FIG. 2 is a block diagram illustrating a configuration of a receiving apparatus according to an exemplary embodiment of the present disclosure. Referring to FIG. 2, the receiving apparatus 200 includes a first receiving unit 210, a demux unit 220, a first signal processing unit 230, a control unit 240, a second receiving unit 250, a second signal processing unit 260, and an output unit 270.

The first receiving unit 210 receives the first signal including the information descriptor that describes the service characteristics, the reference data, and the additional data reference information through the RF communication network. The configuration of the first receiving unit 210 may be implemented in a variety of forms depending on the broadcasting standards. In the case of the ATSC manner, the first receiving unit 210 may include components such as a tuner, a RF down converter, a demodulator, an equalization unit, etc.

The demux unit 220 performs demultiplexing to detect the information descriptor, reference data, and additional data reference information from the first signal.

The information descriptor that is detected in the demux unit 220 is provided to the control unit 240. Also, the reference data that is detected in the demux unit 220 is provided to the first signal processing unit 230.

The first signal processing unit 230 processes the reference data to generate video frames, subtitles, audio signals, etc. The first signal processing unit 230 may include a video processing unit 231, an audio processing unit 232, a graphic processing unit (not illustrated), etc. The video processing unit 231 performs a variety of video signal processes, such as decoding, deinterleaving, scaling, frame rate conversion, etc., related to the video data included in the reference data. The audio processing unit 232 performs a variety of audio signal processes, such as decoding, noise filtering, amplification, etc., related to the audio data included in the reference data. The first signal processing unit 230 may further include a mixer that mixes objects such as the video frames generated in the video processing unit 231, the subtitles generated in the graphic processing unit, other graphic user interfaces, etc., a frame buffer that stores the mixed frames, etc. However, illustrations and descriptions for detailed configurations thereof will be omitted.

The control unit 240 determines the type of service provided by the transmitting apparatus based on the information descriptor. If it is determined as the hybrid service, the control unit 240 controls the second receiving unit 250 to access a source apparatus corresponding to the additional data reference information.

The second receiving unit 250 accesses the source apparatus depending on the additional data reference information, and then, requests additional data. In the broadcasting system as illustrated in FIG. 1, the source apparatus may be the second transmitting apparatus 100-2. The second receiving unit 250 may access the source apparatus through the IP communication network. If the second signal including the additional data is transmitted from the source apparatus in accordance with the request, the second receiving unit 250 receives and provides this to the second signal processing unit 260.

The second signal processing unit 260 processes the additional data included in the second signal. The additional data may also include video data and audio data, or may include only video data according to an embodiment. For example, in the case of 3D content, only left eye image data and audio data may be included in the reference data, and right eye image data may be provided as the additional data. The detailed configuration of the second signal processing unit 260 may vary according to exemplary embodiments of the present disclosure. For example, in an exemplary embodiment in which the additional data includes both video data and audio data, the second signal processing unit 260 may include a video decoder, an audio decoder, etc. like the first signal processing unit 230. On the other hand, in an exemplary embodiment in which the additional data includes only video data, the second signal processing unit 260 may include only components for processing video signals such as a video decoder, a scaler, a frame rate conversion unit, etc.

The output unit 270 synchronizes the reference data processed in the first signal processing unit 230 and the additional data processed in the second signal processing unit 260, and thus, outputs them. The output unit 270 may include a variety of output members such as a display panel, a speaker, etc.

The receiving apparatus 200 as illustrated in FIG. 2 may be controlled by the control unit 240 overall. In other words, if a turn-on command is input through a button provided on the receiving apparatus 200 or an external remote controller, the control unit 240 turns on a power of the receiving apparatus 200, and then, performs initialization. The control unit 240 controls the first receiving unit 210 to tune in to a broadcasting channel based on information about a channel that was previously tuned in to or information about a channel that is set in a default. Accordingly, if the first signal including the information descriptor as described above is received, the receiving apparatus 200 provides the general service or the hybrid service depending on the information descriptor. Since a conventional receiving apparatus, like a conventional television that cannot provide the hybrid service, cannot recognize the information descriptor, it processes and plays only the reference data that is received by the first receiving unit 210. However, the receiving apparatus that has a function to provide the hybrid service not only supports the conventional general broadcasting service, but also can provide the hybrid service depending on the information descriptor. As a result, it has compatibility with the conventional broadcasting receiving apparatus, and can in addition provide the hybrid service.

On the other hand, the output unit 270 may perform synchronization by using various synchronizing information.

For example, a time code may be used as the synchronizing information. The time code is a series of pulse signals created by a time code generator, and is a signal standard that has been developed for easy editing management. When creating and editing content, the same time code is used to manage the synchronization of the left eye images and right eye images. Accordingly, the time code may maintain the same pair regardless of the time when the stream is generated or transmitted. In detail, a society of motion picture and television engineers (SMPTE) time code may be used. In other words. SMPTE 12M expresses the time code in the form of “hours: minutes: seconds: frames”. The SMPTE time code may be divided into a longitude time code (LTC) or a vertical interval time code (VITC) depending on the recording method. LTC is recorded according to an advancing direction of a tape. The LTC may be configured with a plurality of bits of data including time information, user information, synch information, retention areas, and frame mode mark. The VITC is recorded in two horizontal lines within a vertical blanking period of the video signal. SMPTE RP-188 defines an interface standard through which the LTC or VITC type of time code can be transmitted as ancillary data.

If the time code is used as the synchronizing information, the first signal processing unit 230 detects the time code recorded in the video frame of the first signal, and the second signal processing unit 260 detects the time code recorded in the video frame of the second signal. The control unit 240 compares the detected time codes, and thus, selects the video frames having the same time code among the video frames of the first signal and the video frames of the second signal. The control unit 240 checks the difference between the timestamps of the selected video frames, and thus, controls the first and second signal processing units 230 and 260 to compensate the timestamps depending on the checked value.

In other words, according to MPEG standard, the transmission stream for transmitting the broadcasting data includes a program clock reference (PCR), a presentation time stamp (PTS), etc. The PCR means reference time information that causes the receiving apparatus 200 according to the MPEG standard to match the time reference thereof to that of the transmitting apparatus. The receiving apparatus 200 sets the value of the system time clock (STC) depending on the PCR. The PTS means a time stamp that informs a playback time for the synchronization of the image and audio in a broadcasting system according to the MPEG standard. When different signals are transmitted from the different transmitting apparatuses 100-1 and 100-2, the PCR may be different depending on the characteristics of the transmitting apparatuses 100-1 and 100-2. Therefore, even if a playback is performed according to the timestamp matched to the PCR, the synchronization may not be achieved. Accordingly, after the control unit 240 selects the video frames that will be synchronized based on the time code, the control unit 240 may calculate the value of the difference between the time stamps of the selected video frames, and then, may compensate the time stamps of the first and second signals by the value of the difference thereof to perform the synchronization thereof. The first and second signal processing units 230 and 260 store the video frames having the compensated timestamps in a buffer of each thereof, and then, the output unit 270 sequentially detects and outputs the video frames stored in the buffer according to the time stamps. Alternatively, in another exemplary embodiment, after the control unit 240 does not compensate the time stamps and selects the video frames that will be synchronized based on the time code, the control unit 240 may control the output unit 270 to synchronize and output the selected video frames.

As another example, frame index information may be used as the synchronizing information. The frame index information means identifying information given in each frame. Frame numbers may representatively be the frame index information. The frame index information may be written in an event information table (EIT), a PMT, a private stream, a transmitting stream header, etc. of a real-time transmitting stream. The control unit 240 may control the first signal processing unit 230 and the second signal processing unit 260 to match the time stamps of the frames having the same frame index information. The output unit 270 outputs the video frame of each signal based on the compensated time stamps, so the synchronization thereof may be achieved.

In addition, content start information may be used as the synchronizing information. The content start information refers to information that informs a start point of a content consisting of the reference data and additional data. The control unit 240 determines the start point of a multimedia content by using the content start information. Then, the control unit 240 compares the start point with each of the time stamps of frames generated by decoding the video data included in the reference data and the time stamps of frames generated by decoding the video data included in the additional data. Depending on the result of the comparison, the control unit 240 can extract a frame index of each data. The output unit 270 performs synchronization by using the extracted frame index.

Alternatively, a difference value between the time stamps may be used as the synchronizing information. In this case, the control unit 240 detects the video data of the second signal having the timestamp, and calculates the difference value from the timestamp of the video data of the first signal, and then, performs synchronization thereof.

As described above, the receiving apparatus 200 may distinguish the service by using the information descriptor, may obtain the additional data corresponding to the reference data by using the additional data reference information, and may synchronize the additional data with the reference data, thereby outputting them. Hereinafter, various exemplary embodiments of configurations of the information and transmitting methods thereof will be described in detail.

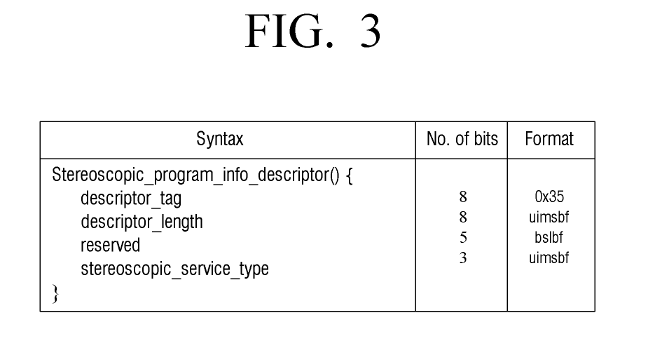

FIG. 3 is an example of syntax of an information descriptor. The information descriptor includes a value for indicating the characteristics of service such that the program is a 2D service, a 3D service, a general service, a hybrid service, etc. Such information may be named differently in a variety of ways, such as a stereoscopic program information descriptor, service information, service characteristic information, etc. However, in the present disclosure, it is referred to as the information descriptor.

Referring to FIG. 3, the information descriptor consists of a total of 24 bits. The stereoscopic service type of FIG. 3 reflects a bit value to define its service type. In detail, the stereoscopic service type is expressed in three bits.

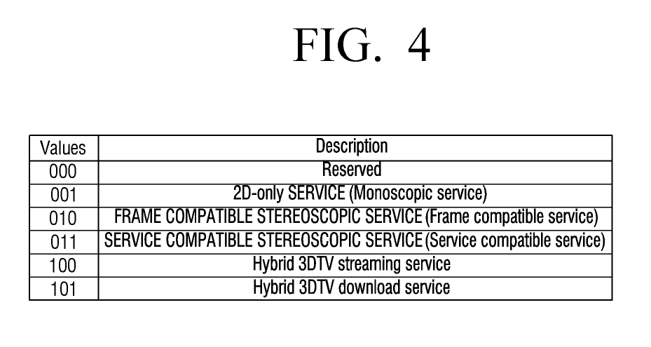

FIG. 4 illustrates a table of the information descriptor that indicates the bit value of the stereoscopic service type and the description thereof.

Referring to FIG. 4, the bit value of the stereoscopic service type may be determined as one of a first value (001) indicating the 2D service, a second value (010) indicating the frame compatible stereoscopic service, a third value (011) indicating a service compatible stereoscopic service, a fourth value (100) indicating a hybrid 3DTV streaming service, and a fifth value (101) indicating a hybrid 3DTV download service.

The 2D service refers to a service to play general 2D content. The frame compatible stereoscopic service and service compatible stereoscopic service refer to a service to play 3D content. Particularly, the frame compatible stereoscopic service refers to a service that shrinks the original resolution of the left and right image frames, and then, arranges them in the form of side-by-side or top-to-bottom, thereby forming a stereo image within one image frame. The service compatible stereoscopic service refers to a method to independently transmit the left and right images to be compatible with existing 2D broadcasting service.

If the information descriptor is described with the first value, the control unit 240 controls the first signal processing unit 230 and output unit 270 to process the reference data of the first signal received from the first receiving unit 210 into 2D data and to output them through the screen and speaker. If the information descriptor is described with the second value or the third value, the control unit 240 receives the 3D data by using the first receiving unit 210, and controls the first signal processing unit 230 and output unit 270 to configure and display left eye image frames and right eye image frames in the format corresponding to the service type.

The first, second, and third values represent bit values for designating the general service. The general service refers to a service that can be provided by using only the signals received through the RF communication network. On the other hand, the fourth and fifth values represent bit values for designating the hybrid service.

If the bit value included in the information descriptor is the fourth value, the control unit 240 controls the second receiving unit 250 to access a source apparatus corresponding to the additional data reference information and to perform streaming. On the other hand, if the bit value included in the information descriptor is the fifth value, the control unit 240 controls the second receiving unit 250 to access the source apparatus and to perform downloading.

The source apparatus may be identified by using accessing information within the additional data reference information. The accessing information may be address information of the source apparatus or the transmitting apparatus, or metadata to identify such address information.

For example, if the bit value of the information descriptor is the fourth value, the control unit 240 may control the second receiving unit 250 to receive streaming of the second signal by using a hypertext transfer protocol (HTTP). The streaming using the HTTP is a streaming manner that can minimize the burden of the server by depending on processing of the client. The second receiving unit 250 performs the streaming by using a file transmission request or a partial file transmission request of the HTTP. The transmitting side uploads files related to a single content that were compressed in various transmission rates into the server, in order to adaptively respond to change of the transmission rate in the network. Also, in order to quickly respond to the state change of the network, the entire content file is divided into multiple files to be saved. The transmitting side provides the receiving side with metadata for informing how to sequentially import the multiple divided files to play multimedia content. The metadata is information for informing where the multimedia content can be received. The metadata file may be distinguished in a variety of types depending on the kinds of HTTP-based streaming. In other words, in the case of a smooth streaming manner, an internet information service (IIS) smooth streaming media (ism) file may be used as the metadata file. In the case of an internet engineering task force (IETF) hypertext transfer protocol (HTTP) live streaming manner, an m3v8 file may be used as the metadata file. In cases of an adaptive HTTP streaming Rel. 9 employed in 3GPP, an adaptive HTTP streaming Rel. 2 may be employed in OIPF, a dynamic adaptive streaming over HTTP manner may be employed in MPEG, and a media presentation description (MPD) may be used as the metadata file. The metadata file may include information that the client needs to know in advance such as locations in the content time that correspond to the multiple divided files. URLs of the sources that will provide the corresponding files, size, etc. The above-described source apparatus means a source from which these metadata files may be obtained. The address information about the source may be included in the additional data reference information within the first signal.

As described above, if it is determined as the hybrid service by the information descriptor, the control unit 240 obtains the additional data based on the additional data reference information. The additional data reference information may be provided to the receiving apparatus 200 in a variety of manners depending on the particular embodiment.

In detail, the additional data reference information may be recorded in at least one of a virtual channel table (VCT) of PSIP, an event information table (EIT), and a program map table (PMT) of program specific information within the first signal. Also, the additional data reference information may be transmitted in the form of metadata.

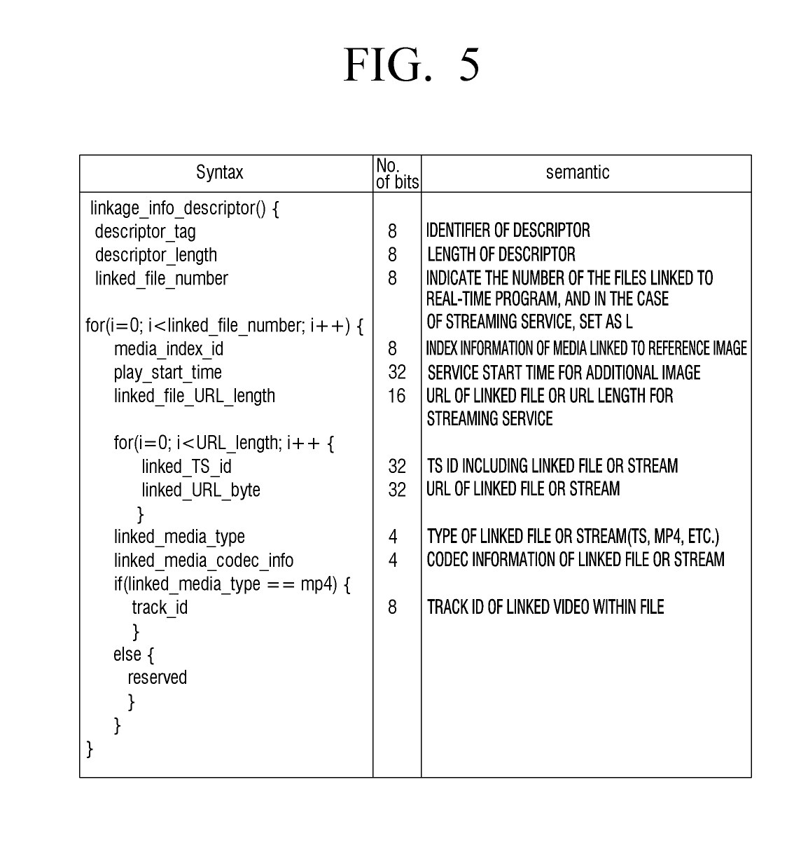

FIG. 5 is an example of an information descriptor to describe the additional data reference information in the program and system information protocol (PSIP). The descriptor as illustrated in FIG. 5 may be located in a VCT of the PSIP or EIT.

Referring to FIG. 5, the additional data reference information may include a delivery form of IP-based additional data that will be linked, the number of additional data that will be linked, URL information of a source to provide the additional data that will be linked, a type of the additional data that will be linked, etc. The additional data transmitted by the IP-based network may be file-based content in the form of download or a transmission stream in the form of streaming.

In FIG. 5, the descriptor tag indicates an identifier of the corresponding descriptor, and the descriptor length indicates a total length of fields that will be described thereafter. The additional data transmitted by the IP-based network may be transmitted in the form of the file download or the streaming, and the use of the detailed fields of the descriptor varies according to the delivery method.

For example, when the additional data is transmitted in the form of file download, since one or more files linked to real-time broadcasting may be prepared, the number of the files linked to the real-time broadcasting is indicated by using the linked_file_number. However, when the additional data is transmitted in the form of streaming, since only URI information having information about each of the URIs configuring the streaming service is needed, the value of the linked_file_number field may be set as 1. The media_index_id gives an id value to identify the additional data linked to the real-time broadcasting. The play_start_{—} time indicates service start time information for each file in the case of the download service, and indicates a service start time for the additional data in the case of the streaming service.

In addition, the address information, that is, URL information to access the additional data file linked to the real-time broadcasting is required. Since the URL information has a variable length, the length of the linked URL information is specified by the linked_file_URL_length, and the linked_URL_byte is used to indicate detailed URL information. In the case of the download service, the URI information may include the URL information for each of the content files corresponding to the real-time broadcasting content. On the other hand, in the case of the streaming service, since only the URL information for receiving the entire linked stream is needed, the URL length is specified by the linked_file_URL_length, and the URI for receiving the additional image stream is specified by using the linked_URL_byte. The additional data stream specified in the URI has URL information of each segment unit.

In addition, the linked_media_type indicates the kind of the file that will be linked. For example, if several elementary streams (EX) exist within one file like mp4 files, the track_id is specified depending on the kind of the file. The linked_media_codec_info indicates codec information of the file or the stream that will be linked.

On the other hand, the additional data reference information may be transmitted in the form of metadata.

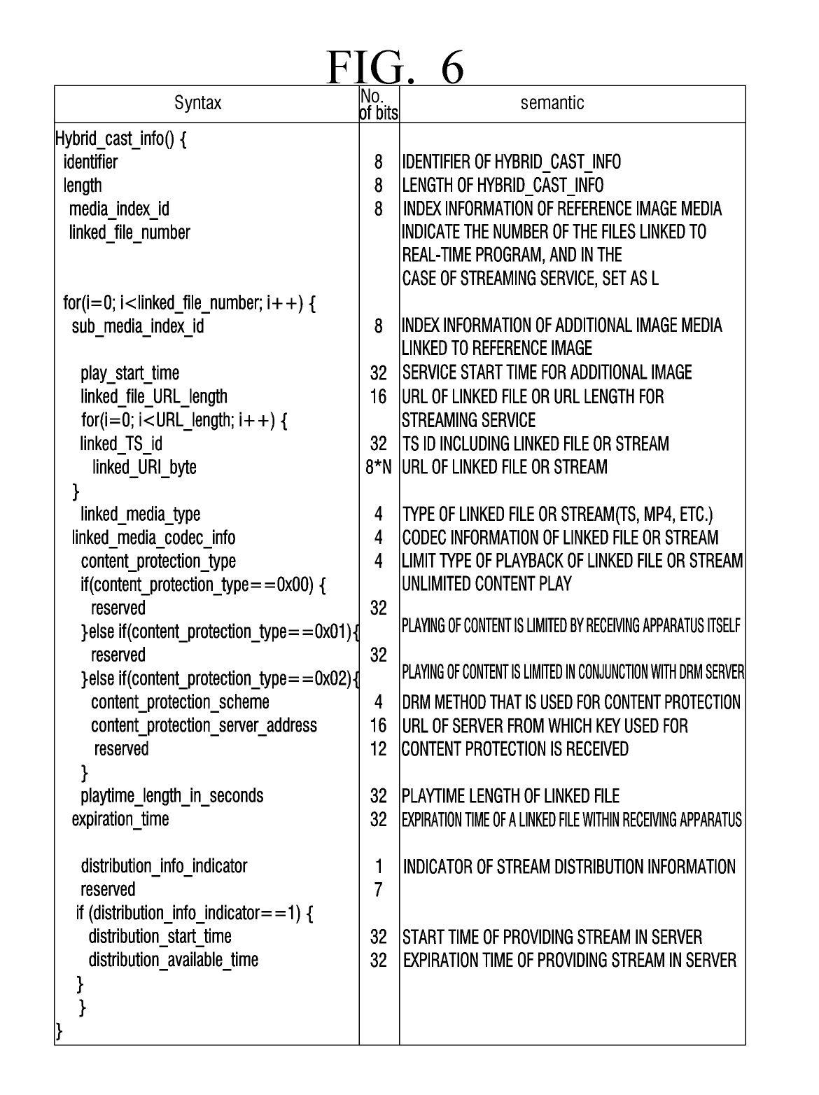

FIG. 6 illustrates a structure of metadata according to an exemplary embodiment for providing additional data reference information by using the metadata structure.

Referring to FIG. 6, the metadata including the additional data reference information may include a transmission format of the IP-based additional data that will be linked, the number of the additional data that will be linked, URL information of the additional data that will be linked, a type of the additional data that will be linked, a play start time of the additional data that will be linked, a playtime length of the additional data that will be linked, an expiration time within a receiving apparatus of the additional data that will be linked, a protection method of the additional data that will be linked, a start time of providing the additional data that will be linked in a server, an expiration time within a server of the additional data that will be linked, etc. The additional data that are transmitted by the IP-based network includes file-based content in the form of download or a transmitting stream in the form of streaming as described above.

In FIG. 6, the identifier indicates an identifier of Hybrid_cast_info( )that is provided through the metadata, and the length indicates the total length of fields that will be described later. The media_index_id is provided as an id value that identifies the reference image. If the value of the media_index_id is different between the Hybrid_cast_info( ) the receiving apparatus 200 can understand that information of different program units are being provided. The use of the detailed fields of the descriptor within the metadata may vary depending on the transmission method of the additional data that are transmitted by the IP-based network.

For example, when the additional data is transmitted in the form of a file download, since one or more files linked to real-time broadcasting may be prepared, the number of the files linked to the real-time broadcasting is indicated by using the linked_file_number. On the other hand when the additional data is transmitted through the streaming service, since URI information having information about each of URIs configuring the streaming service is needed (not the number of files that will be linked), the value of the linked_file_number field may be set as 1.

The sub_media_index_id gives an id value to identify the additional data linked to the real-time broadcasting. The play_start_time indicates service start time information for each file in the case of the download service, and indicates a service start time for the additional image in the case of the streaming service.

In addition, URL information to access the additional image file linked to the real-time broadcasting is needed. Since the URL information has a variable length, the length of the linked URL information is specified by the linked_file_URL length, and the linked_URL_byte is used to indicate detailed URL information.

In the case of the download service, the URI information may include the URL information for each of content files corresponding to the real-time broadcasting content. In the case of the streaming service, since only the URL information for receiving the entire linked stream is needed, the URI length is specified by the linked_file_URL_length, and the URI for receiving the additional image stream is specified by using the linked_URL_byte. The additional image stream specified in the URI has URL information of each segment unit.

The linked_media_type has container format information of link type content such as MP4 or TS. The linked_media_codec_info has information of a codec configuring the link type content.

The content_protection_type instructs a content protection method for preventing content that is pre-downloaded prior to the playing time from being played prior to the specific time in the case of the download service. For example, in the download service, the value of the content_protection_type may be provided as one of 0x00, 0x01, and 0x02. The 0x00 is information that instructs not to perform content protection. The 0x01 may be information that instructs to prevent the content from being played by a protection method of the receiving apparatus itself. Also, the 0x02 indicates to control content playback in conjunction with a DRM server connected through the IP network. The content_protection_scheme field and the content_protection_server_address field provide detailed information about a DRM method and an address of the DRM linked server. In the case of the streaming service, since the value of the content_protection_type is not needed, the content_protection_type field has the value of 0x00.

The playtime_length_in_seconds indicates a length of the content play time calculated from the time of the play_start_time field in the case of download service. The expiration time indicates a valid time of the content stored within the receiving apparatus. In the case of the streaming service, since the values of the playtime_length_in_seconds and expiration_time are not needed, they have the value of 0x00000000.

The distribution_info_indicator is an indicator to represent that the information related to a start time of providing the content and an expiration time of providing the content in the server, is being displayed. If the value of the distribution_info_indicator is 0x1, the start time and expiration time for which the receiving apparatus can access the server may be indicated through the distribution_start_time and the distribution_available_time.

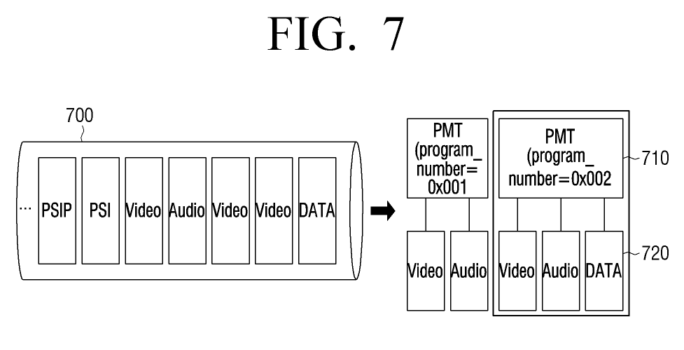

FIG. 7 illustrates a structure of a metadata stream including the additional data reference information. Referring to FIG. 7, in a program multiplexing step for transmitting the reference data through the RF broadcasting network, the additional data reference information may be configured as a separate metadata stream, and then, may be multiplexed and transmitted with the media streams constituting the broadcasting program.

Referring to FIG. 7, a first signal 700 includes a PSIP, a PSI, video data, audio data, etc. A PMT includes signaling information about the video data, audio data, metadata, etc. If a metadata stream 720 is provided, the PMT 710 defines the type of the stream, and may signal the metadata to the receiving apparatus 200.

The location of the metadata may be defined by a packet elementary stream (PES) packet, a section, a private section, private data, etc. Accordingly, the value of the stream type for signaling the transmitted metadata stream is recorded in the PMT, and then, is transmitted. For example, when the metadata is transmitted in the PES packet level, stream type=0x15, when it is transmitted in the section level, stream type=0x16, when it is included in the private section, stream type=0x05, and when it is transmitted in the private data, stream type=0x06. In addition, a new stream type may be defined and used. Alternatively, the metadata stream may be transmitted through the IP communication network.

As described above, if the information descriptor and additional data reference information are provided to the receiving apparatus 200, the receiving apparatus 200 can provide the hybrid service that properly synchronizes and outputs the reference data and additional data by using them.

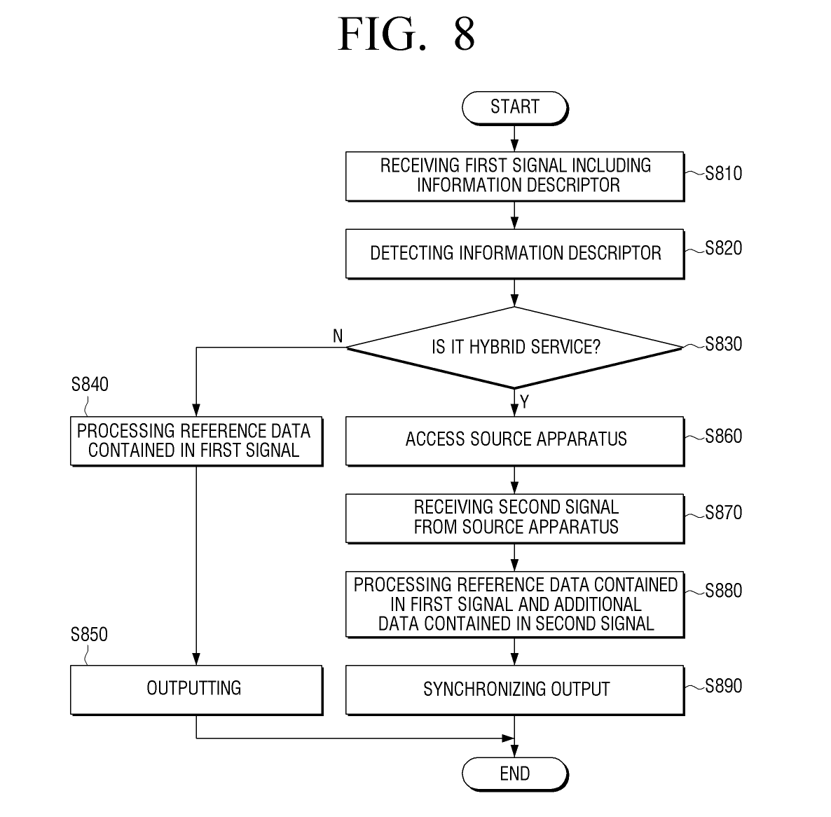

FIG. 8 is a flowchart for explaining a service providing method in a receiving apparatus according to an exemplary embodiment of the present disclosure. Referring to FIG. 8, the receiving apparatus receives a first signal including an information descriptor (S810). The receiving apparatus detects the information descriptor from the first signal (S820), and then, determines whether a hybrid service exists or not (S830). If the information descriptor is defined as one of the first to fifth values as illustrated in FIG. 4, when the information descriptor is the fourth value or the fifth value, the receiving apparatus determines that it is the hybrid service.

If it is determined as the general service (not the hybrid service), the receiving apparatus processes and outputs only reference data included in the first signal (S840 and S850).

On the other hand, if it is determined as the hybrid service, the receiving apparatus accesses a source apparatus by using additional data reference information (S860). The additional data reference information may be included in the first signal or may be formed in a separate signal to be provided through an IP communication network. The kinds and transmitting methods of the additional data reference information are described in detail in the above description; therefore, duplicate descriptions thereof will be omitted.

After accessing the source apparatus, the receiving apparatus receives a second signal from the source apparatus (S870). The second signal includes additional data corresponding to the reference data. After the second signal is received, the receiving apparatus processes each of the additional data included in the second signal and the reference data included in the first signal (S880), and then, synchronizes and outputs them (S890).

Examples of the synchronizing information used to synchronize the output and synchronization methods are described in detail in the above description; therefore, duplicate description thereof will be omitted.

As a result, since large-size content can be effectively serviced by using a plurality of different communication networks like the RF communication network and IP communication network, band-limitation problems may be resolved.

On the other hand, in the system as illustrated in FIG. 1, the first and second transmitting apparatuses 100-1 and 100-2 are described to be apparatuses independent from each other. For example, the first transmitting apparatus 100-1 may be implemented as a broadcasting station, and the second transmitting apparatus 100-2 may be implemented as a web server. Content producers may divide content that they own or produced into a plurality of data, and then, may coordinate with the broadcasting station and a contact person of the web server in order to transmit each of them through different communication networks. Alternatively, the content producers may have both a broadcast transmitting apparatus and server apparatus, and then, may provide a hybrid service by using them. As such, the configuration of the transmitting side may be designed in a variety of manners. Hereinafter, the transmitting side will be referred to as a transmitting system.

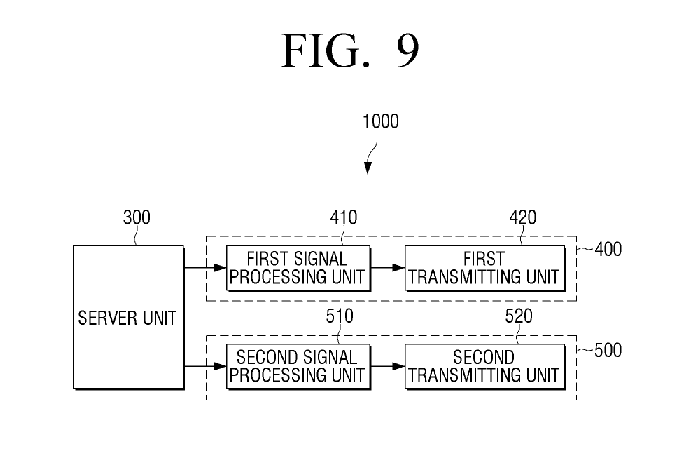

FIG. 9 is a block diagram illustrating a configuration of a transmitting system according to an exemplary embodiment of the present disclosure. Referring to FIG. 9, the transmitting system 1000 includes a server unit 300, a first signal processing unit 410, a first transmitting unit 420, a second signal processing unit 510, and a second transmitting unit 520.

The server unit 300 is configured to provide reference data and additional data composing a single content. In detail, in the case of 3D content, the server unit 300 may define left eye video data and audio data as the reference data, and may define right eye video data as the additional data. Alternatively, in the case of moving image content, the server unit 300 may define video data as the reference data, and audio data as the additional data.

The server unit 300 may receive a user's command for specifying the kind of service to provide, or may automatically select the kind of service depending on a predetermined setting value, and thus, may operate according to the kind of service that is received or selected. For example, when providing the hybrid service, the server unit 300 divides the reference data and additional data depending on the predetermined reference as described above, and then, provides each data to the first signal processing unit 410 and the second signal processing unit 510. Then, the server unit 300 provides the first signal processing unit 410 and the second signal processing unit 510 with an information descriptor to describe the characteristics of the service, additional data reference information including a variety of information to synchronize the reference data and additional data, etc.

The first signal processing unit 410 generates a first signal including the reference data, information descriptor, and additional data reference information provided from the server unit 300. The first transmitting unit 420 transmits the generated first signal through the RF communication network.

On the other hand, the second signal processing unit 510 generates a second signal including the additional data provided from the server unit 300.

The second transmitting unit 520 may transmit the second signal to the receiving apparatus through the IP communication network. According to exemplary embodiments, the second transmitting unit 520 may transmit the second signal when receiving a request for the second signal from the receiving apparatus, and also may automatically transmit the second signal by using information of the receiving apparatus after the first signal is transmitted. Also, the transmission of the second signal may be performed in the streaming manner or in the download manner.

FIG. 9 illustrates that entire components configure one transmitting system. However, the first signal processing unit 410 and first transmitting unit 420 may be implemented as one independent broadcasting apparatus 400, and the second signal processing unit 510 and second transmitting unit 520 may be implemented as one independent server apparatus 500.

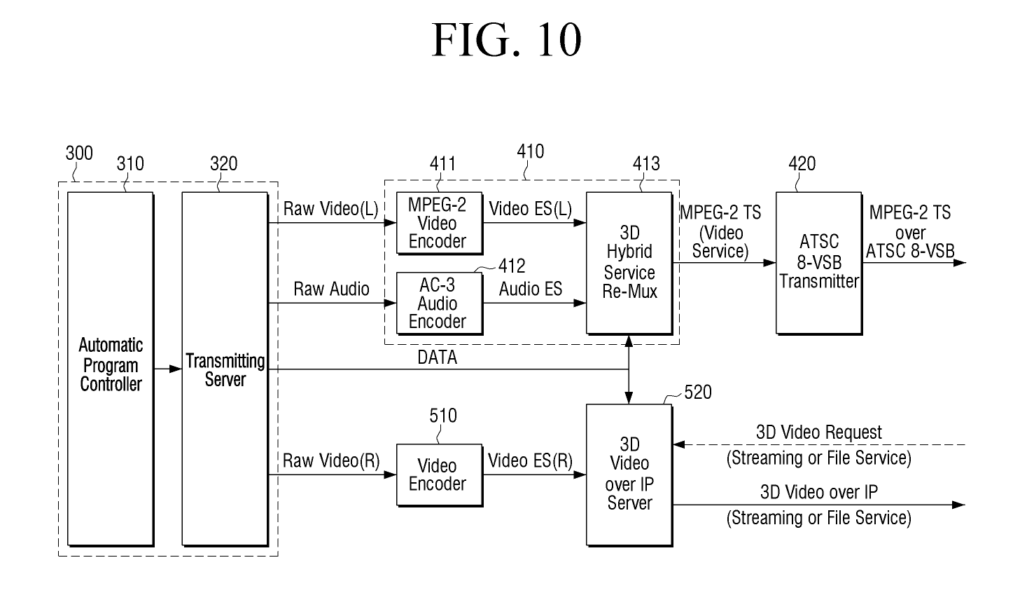

FIG. 10 is a block diagram illustrating a detailed configuration of the transmitting system of FIG. 9. Referring to FIG. 10, the server unit 300 may include an automatic program controller 310 and a transmitting server 320. The automatic program controller 310 may select the general service or the hybrid service as a service depending on a user's command, a setting value, content characteristics, etc.

Depending on the selected result, the automatic program controller 310 controls the transmitting server 320 to divide the content into a plurality of data and to transmit them.

The transmitting server 320 stores produced content, and acts to transmit the stored content depending on the control of the automatic program controller 310. The transmitting server 320 provides the reference data to the first signal processing unit 410. FIG. 10 illustrates that the reference data that was divided into left eye raw video data (L) and raw audio data is provided to the first signal processing unit 410; however, if the first signal processing unit 410 has a demux, the reference data may be divided by the demux.

The left eye raw video data is input into the a video encoder 411 within the first signal processing unit 410, and the raw audio data is input into an audio encoder 412 within the first signal processing unit 410. FIG. 10 is illustrated so that the video encoder 411 is implemented as an MPEG-2 video encoder, and the audio encoder 412 is implemented as an AC-3 audio encoder.

The video encoder 411 and audio encoder 412 encode the video data and audio data, respectively, and thus, output a left eye video elementary stream (ES) and an audio elementary stream (ES). A remux 413 performs muxing of the left eye video ES, audio ES, and various data provided from the transmitting server 320 to generate a first signal. In FIG. 10, considering that the remux is used in the 3D hybrid service, it is designated as a 3D hybrid service remux 413; however, the name may be changed in various ways. In FIG. 10, since MPEG-2 encoding method is used, the first signal generated in the remux 413 may be an MPEG-2 transport stream (TS).

The first transmitting unit 420 processes the first signal provided from the remux 413 in the form of a transmitting signal, and thus, transmits it. FIG. 10 illustrates use of the ATSC standard of the above-described variety of broadcasting standards. Accordingly, the first transmitting unit 420 modulates the MPEG-2 TS according to 8-VSB modulation method, and then, transmits it through the RF communication network.

On the other hand, the transmitting server 320 provides the additional data to the second signal processing unit 510. FIG. 10 illustrates that right eye raw video data (R) are provided to the second signal processing unit 510. The second signal processing unit 510 encodes the right eye raw video data to generate a video ES by using one of a variety of encoding methods. The second signal processing unit 510 may receive a variety of information, such as additional data reference information, information descriptor, etc., in addition to the additional data from the transmitting server 320, and then, may generate video ES by using the information. For example, synchronizing information may be added to the video ES.

The second transmitting unit 520 transmits the generated video ES to the receiving apparatus 200. If a 3D video request is received through the IP communication network, the second transmitting unit 520 may transmit the video ES, namely, the second signal in response to the request. The second signal may be transmitted in the streaming manner or in a file download method.

When the general service is provided, the lower path of FIG. 10, that is, the second signal processing unit 510 and second transmitting unit 520 may be deactivated. In other words, the transmitting system as illustrated in FIGS. 9 and 10 may compatibly provide the general service and hybrid service.

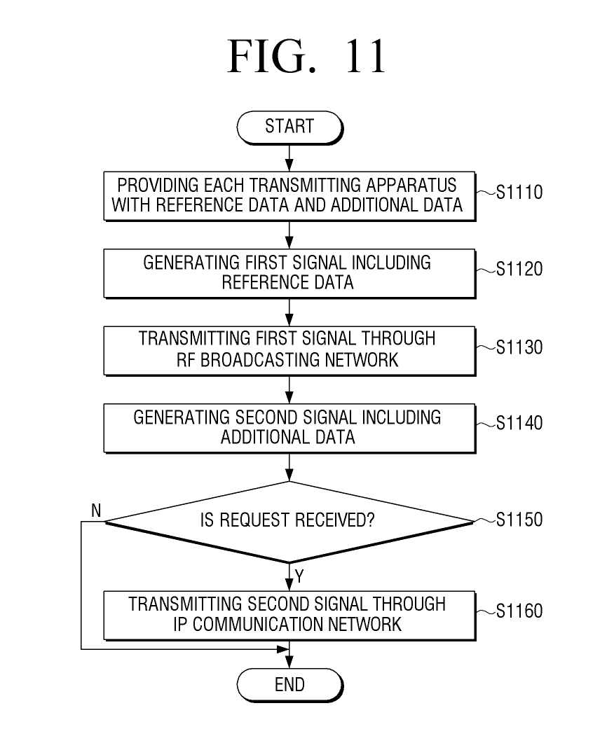

FIG. 11 is a flowchart for explaining a service providing method of a transmitting system according to an exemplary embodiment of the present disclosure. Referring to FIG. 11, the transmitting system provides each of the transmitting apparatuses with the reference data and additional data (S1110). A first transmitting apparatus that received the reference data generates a first signal including the reference data (S1120). The first signal has a format corresponding to the digital broadcasting standards. The first generated signal is broadcasted through the RF broadcasting network (S1130). Then, the transmitting system generates a second signal including the additional data (S1140).

On the other hand, the receiving apparatus that tunes into the first signal broadcasted, and then, may grasp the characteristics of the service by using the information descriptor contained in the first signal. Accordingly, if the service is determined as the hybrid service, the receiving apparatus may request additional data from a source by using additional data reference information. Here, the source may be the second transmitting apparatus within the transmitting system.

If the additional data request is received from the receiving apparatus (S1150), the transmitting system transmits the second signal as described above through the IP communication network in response to the request (S1160).

FIG. 11 is illustrated so that after the second signal has been previously generated, at the time of receiving the request, the second signal is transmitted. However, operation to generate the second signal may be performed after the request is received.

In other words, the order of detailed steps of the various methods as described above may change, and some thereof may be omitted.

According to various exemplary embodiments as described above, various types of broadcasting services may be provided by using both the digital broadcasting network and IP network. Particularly, since the reference data is transmitted by using the existing 2DTV broadcasting system and the additional data are transmitted by using IP network, they can be compatible with the existing 2D broadcasting system, and can overcome the bandwidth limitation that occurs at the time of transmitting content of high-capacity size such as 3D content, ultra high-definition (UHD) broadcasting content, etc.

In addition, the exemplary embodiments as described above may be applied to a data broadcasting service system that transmits 2D broadcasting through the broadcasting network and transmits data such as multi-language audio, multi-language subtitles, etc. through the IP network. Also, the exemplary embodiments may be applied to a UHD broadcasting service system that transmits 2D broadcasting through the broadcasting network and transmits UHD broadcasting data through the network. In addition, the exemplary embodiments may be applied to a multi-view broadcasting service system that transmits 2D broadcasting through the broadcasting network and transmits data such as depth maps, another point of view, etc. through the network, or a multi-angle service system that transmits 2D broadcasting through the broadcasting network and provides image data of different shooting angles through the network.

The service providing methods according to various exemplary embodiments as described above may be coded as software, and thus, may be mounted in a variety of apparatuses.

In detail, a non-transitory computer-readable medium having stored therein a program according to an exemplary embodiment of the present disclosure that performs a step of receiving a first signal including an information descriptor that describes service characteristics, reference data, and additional data reference information through a RF communication network, a step of detecting the information descriptor from the first signal, a step of if it is determined as a hybrid service depending on the information descriptor, accessing a source apparatus corresponding to the additional data reference information through an IP network, a step of receiving a second signal including additional data from the source apparatus, a step of processing each of the reference data contained in the first signal and the additional data contained in the second signal, and a step of synchronizing and outputting the processed reference data and additional data, may be disposed in the variety of apparatuses.

The non-transitory computer-readable medium means is not a medium to store data for a short moment like a register, a cache, a memory, etc., but is a medium that can store data in a semi-permanent and can be read by devices. In detail, the various applications or programs as described above may be stored in the non-transitory computer readable medium, such as a compact disc (CD), a digital versatile disc (DVD), a hard disc, a Blu-ray disc, a universal serial bus (USB), a memory card, a read-only memory (ROM), etc., and thus, may be provided to.

While the exemplary embodiments of the present disclosure have been described, additional variations and modifications of the exemplary embodiments may occur to those skilled in the art once they learn of the basic inventive concepts. Therefore, it is intended that the appended claims shall be construed to include both the above exemplary embodiments and all such variations and modifications that fall within the spirit and scope of the inventive concepts.

What is claimed is:

1. A receiving apparatus comprising:
a first receiver configured to receive a first signal comprising a descriptor to describe service characteristics, reference data, and additional data reference information through a first network;
a second receiver operable to be connected to a second network;
a demultiplexer configured to detect the descriptor, the reference data, and the additional data reference information from the first signal;
a first signal processor configured to process the reference data detected in the demultiplexer;
a controller configured to control the second receiver to access a source apparatus corresponding to the additional data reference information, if a hybrid service is determined based on the descriptor;
a second signal processor configured to process the additional data, if a second signal comprising additional data is received from the source apparatus through the second network; and
an outputter configured to synchronize and output the reference data processed in the first signal processor and the additional data processed in the second signal processor.

2. The receiving apparatus of claim 1, wherein
the descriptor comprises a bit value that specifies a type of service, and
the bit value comprises at least one from among a first value that indicates a 2D service, a second value that indicates a frame compatible stereoscopic service, a third value that indicates a service compatible stereoscopic service, a fourth value that indicates a hybrid 3DTV streaming service, and a fifth value that indicates a hybrid 3DTV download service.

3. The receiving apparatus of claim 2, wherein,
if the bit value contained in the descriptor is the fourth value, the controller controls the second receiver to access the source apparatus and to perform streaming, and
if the bit value contained in the descriptor is the fifth value, the controller controls the second receiver to access the source apparatus and to perform a download.

4. The receiving apparatus of claim 1, wherein the descriptor is recorded in at least one from among a terrestrial virtual channel table (TVCT), an event information table (EIT), and a program map table (PMT) within the first signal.

5. The receiving apparatus of claim 4, wherein
the additional data reference information comprises at least one from among broadcasting service type information, additional image type information, accessing information related to the addition data, additional image start time information, and synchronizing information.

6. The receiving apparatus of claim 5, wherein
the additional data reference information is contained in at least one from among
a virtual channel table (VCT), an event information table (EIT) related to a program and system information protocol (PSIP), a program map table (PMT), and a metadata stream of program specifying information.

7. A service providing method comprising:
receiving a first signal comprising a descriptor to describe at least one from among service characteristics, reference data, and additional data reference information through a first network:
detecting the descriptor from the first signal;
accessing, if a hybrid service is determined based on the descriptor, a source apparatus corresponding to the additional data reference information through a second network;
receiving a second signal comprising additional data from the source apparatus;
processing the reference data contained in the first signal and the additional data contained in the second signal, respectively; and
synchronizing and outputting the processed reference data and additional data.

8. The service providing method of claim 7, wherein
the descriptor comprises a bit value that specifies a type of service, and
the bit value comprises at least one from among a first value that indicates a 2D service, a second value that indicates a frame compatible stereoscopic service, a third value that indicates a service compatible stereoscopic service, a fourth value that indicates a hybrid 3DTV streaming service, and a fifth value that indicates a hybrid 3DTV download service.

9. The service providing method of claim 8, wherein,
the receiving the second signal comprises,
if the bit value contained in the descriptor is the fourth value, receiving streaming of the additional data from the source apparatus, and
if the bit value contained in the descriptor is the fifth value, downloading the additional data from the source apparatus.

10. The service providing method of claim 7, wherein
the descriptor is recorded in at least one from among a terrestrial virtual channel table (TVCT), an event information table (EIT), and a program map table (PMT) within the first signal.

11. The service providing method of claim 10, wherein
the additional data reference information comprises at least one from among broadcasting service type information, additional image type information, accessing information about the addition data, additional image start time information, and synchronizing information.

12. The service providing method of claim 10, wherein
the additional data reference information is contained in at least one from among
a virtual channel table (VCT), an event information table (EIT) of a program and system information protocol (PSIP), and one from among a program map table (PMT) and a metadata stream of program specifying information.

13. A transmitting system comprising:
a server configured to provide reference data and additional data related to a single content;
a first signal processor configured to generate a first signal comprising the reference data, descriptor that describes service characteristics of the content, and additional data reference information;
a first transmitter configured to transmit the first signal through a first network;
a second signal processor configured to generate a second signal comprising additional data; and
a second transmitter configured to transmit the second signal in a form of one of a stream and a file, if a request for the second signal is received from a receiving apparatus.

14. The transmitting system of claim 13, wherein
the descriptor comprises a bit value that specifies a type of service, and
the bit value comprises at least one from among a first value that indicates a 2D service, a second value that indicates a frame compatible stereoscopic service, a third value that indicates a service compatible stereoscopic service, a fourth value that indicates a hybrid 3DTV streaming service, and a fifth value that indicates a hybrid 3DTV download service.

15. The transmitting system of claim 13, wherein
the descriptor is recorded in at least one from among a terrestrial virtual channel table (TVCT), an event information table (EIT), and a program map table (PMT) within the first signal.

16. The transmitting system of claim 15, wherein
the additional data reference information comprises at least one from among broadcasting service type information, additional image type information, accessing information about the addition data, additional image start time information, and synchronizing information, and
the additional data reference information is contained in at least one from among a virtual channel table (VCT), or an event information table (EIT) of a program and system information protocol (PSIP), and a program map table (PMT) or a metadata stream of program specifying information.

17. A service providing method of a transmitting system comprising:
providing reference data and additional data related to a single content;
generating a first signal comprising the reference data, a descriptor that describes service characteristics of the single content, and additional data reference information;
transmitting the first signal through a first network;
generating a second signal comprising additional data; and
transmitting, if a request for the second signal is received from an apparatus, the second signal in a form of one of a stream and a file.

18. The service providing method of claim 17, wherein
the descriptor comprises a bit value that specifies a type of service, and
the bit value comprises at least one from among a first value that indicates a 2D service, a second value that indicates a frame compatible stereoscopic service, a third value that indicates a service compatible stereoscopic service, a fourth value that indicates a hybrid 3DTV streaming service, and a fifth value that indicates a hybrid 3DTV download service.

19. The service providing method of claim 17, wherein
the descriptor is recorded in at least one from among a terrestrial virtual channel table (TVCT), an event information table (EIT), and a program map table (PMT) within the first signal.

20. The service providing method of claim 19, wherein
the additional data reference information comprises at least one from among broadcasting service type information, additional image type information, accessing information about the addition data, additional image start time information, and synchronizing information, and
the additional data reference information is contained in at least one from among a virtual channel table (VCT), an event information table (EIT) related to a program and system information protocol (PSIP), and one from among a program map table (PMT) and a metadata stream of program specifying information.

21. The receiving apparatus of claim 1, wherein the first network is a radio frequency (RF) network and the second network is an internet protocol (IP) network.

22. The service providing method of claim 7, wherein the first network is a radio frequency (RF) network and the second network is an internet protocol (IP) network.

23. The transmitting system of claim 13, wherein the first network is a radio frequency (RF) network.

24. The service providing method of claim 17, wherein the first network is a radio frequency (RF) network.
